(19) United States
(12) Patent Application Publication
(10) Pub. No.: US 2021/0289927 A1
(43) Pub. Date: Sep. 23, 2021

(54) PHONE HOLDER

(71) Applicant: Murad H. Kozelian, JR., Belmont, MA (US)

(72) Inventor: Murad H. Kozelian, JR., Belmont, MA (US)

(21) Appl. No.: 16/826,715

(22) Filed: Mar. 23, 2020

(51) Int. Cl. A45F 5/00; H04M 1/04; H04B 1/3827

(52) U.S. Cl. CPC A45F 5/00; H04M 1/04; H04B 2001/3861; A45F 2200/0516; H04B 1/385

(57) ABSTRACT

A phone holder for use with a mobile telephone, the phone holder including a generally planar base attachable to a rear side of a mobile telephone and a spring bar attached to the base. The spring bar being angularly disposed relative to the base in a normal position. A spring is coupled between the base and the spring bar, the spring being configured to urge the spring bar towards the base when the spring bar is moved outwardly from the base beyond the normal position. In one embodiment the spring bar includes a rubberized portion for engaging a user's fingers to secure a mobile telephone in the user's hand.

### FIELD OF THE INVENTION

The present disclosure relates generally to a phone holder. More particularly, the disclosure relates to a phone holder attachable to a mobile phone including a base and a spring bar attached to the base. The spring bar defining a cut-out area providing space for a users fingers while the user grips the mobile phone via the phone holder.

### BACKGROUND OF THE INVENTION

The statements in this section merely provide background information related to the present disclosure and may not constitute prior art.

Many different types of holders are currently available which typically attach to a rear side of a mobile phone or a phone case and provide an outwardly extending handle such as a “popsocket” or a strap, or other handle by which a user can securely grasp their phone. Thus, many prior phone holders are configured wherein a user is required to grasp a handle or other structure attached to the phone to support the phone.

Accordingly, it is an object of the present teachings to provide a phone holder that overcomes the shortcomings of prior art phone holders

### SUMMARY OF THE INVENTION

A phone holder for use with a mobile telephone is disclosed. The phone holder including a generally planar base attachable to a rear side of a mobile telephone and a spring bar attached to the base. The spring bar being angularly disposed relative to the base in a normal position. A spring is coupled between the base and the spring bar, the spring being configured to urge the spring bar towards the base when the spring bar is moved outwardly from the base beyond the normal position. In one embodiment the spring bar includes a rubberized portion for engaging a user's fingers to secure a mobile telephone in the user's hand.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description, the appended claims and the following drawings. The drawings are for illustrative purposes only and are not intended to limit the scope of the present disclosure.

FIG. 1 is a perspective view of one embodiment of a phone holder in accordance with the present invention shown attached to a mobile phone and as used by a user to secure the mobile phone in the hand of a user;

FIG. 2 is an exploded perspective view of a phone holder in accordance with the present invention shown aligned with a rear side of a mobile phone prior to attachment thereto;

FIG. 3 is a perspective view of the rear side of a mobile phone showing a phone holder in accordance with the present invention attached thereto;

FIG. 4 is a front side elevational view of the phone holder of FIG. 3;

FIG. 5 is a rear side elevational view of the phone holder of FIG. 4;

FIGS. 6 and 7 are left and right-side elevational views of the phone holder of FIG. 4, respectively;

FIG. 8 is a top side plan view of the phone holder of FIG. 3; and

FIG. 9 is a bottom side view of the phone holder of FIG. 3.

### DETAILED DESCRIPTION OF EMBODIMENTS OF THE INVENTION

Detailed illustrative descriptions of example embodiments are disclosed herein. However, specific structural and functional details disclosed herein are merely representative for purposes of describing example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between”versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the language explicitly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

FIG. I shows a phone holder 10 attached to a rear side 12 of a mobile phone 20. A hand 22 of a user is shown holding the mobile phone 20 with the user's fingers 24 positioned between the phone holder 10 and the rear side 12 of the mobile phone, and includes the index finger resting against an outer surface of the phone holder 10.

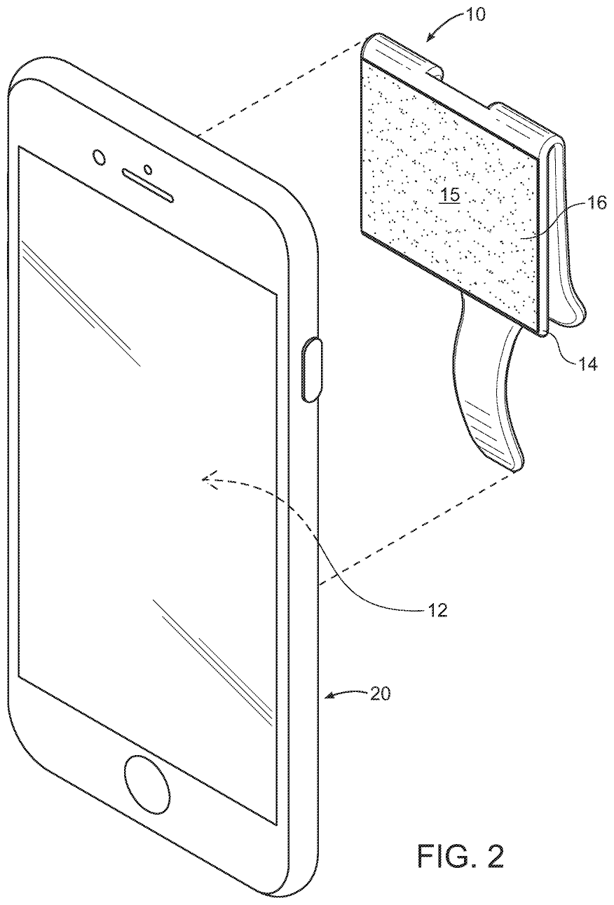

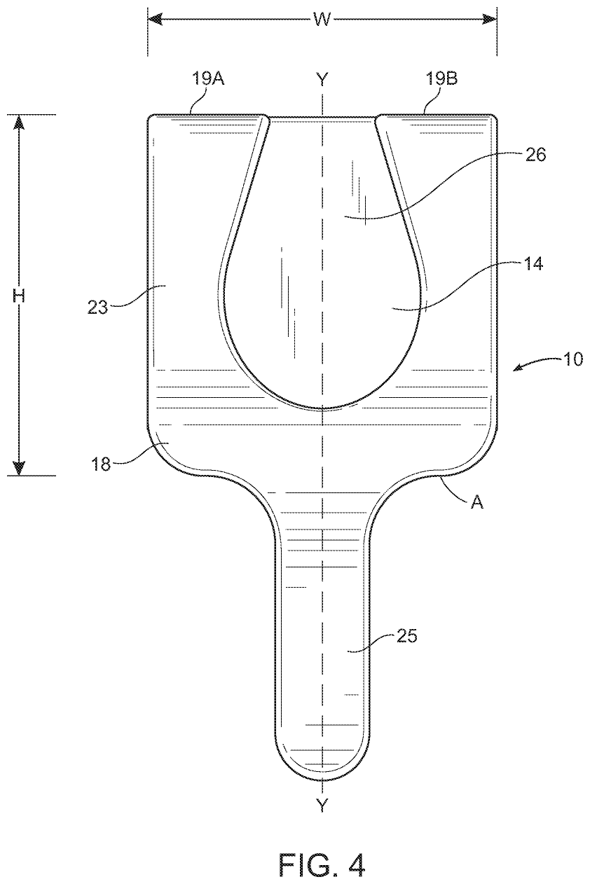

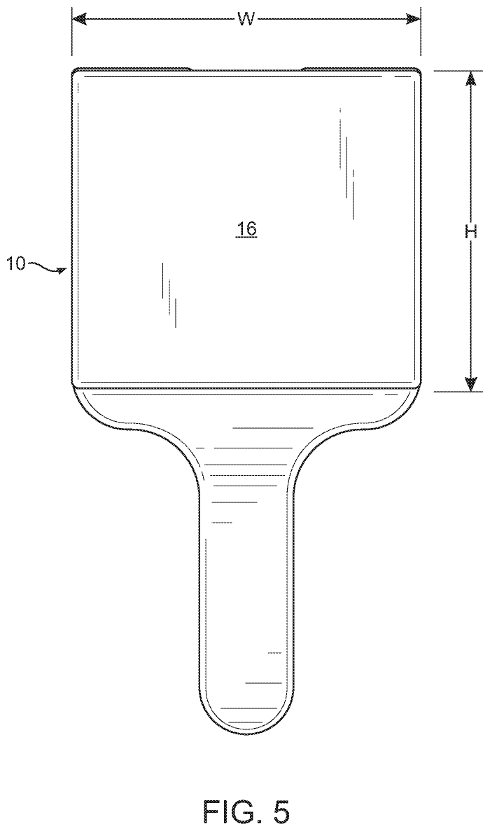

Referring to FIGS. 2-7, the phone holder 10 includes a base 14 having a generally planar first side 15 attachable via adhesive 16 to the rear side 12 of a mobile phone 20 or a case or protective cover for the mobile phone (not shown), and a spring bar 18 attached to the base 14 via at least one hinge or spring 19. In one embodiment, the adhesive 16 includes an adhesive layer attached to the first side 15 of the base 14. The base 14 is generally rectangular, square or semi-circular having a width W as shown in FIG. 4. In the FIG. 4 embodiment, a height H of the first portion 23 is about equal to the width W. In one embodiment, the width W of the first portion 23 is between about 1.5 inches and about 2 inches.

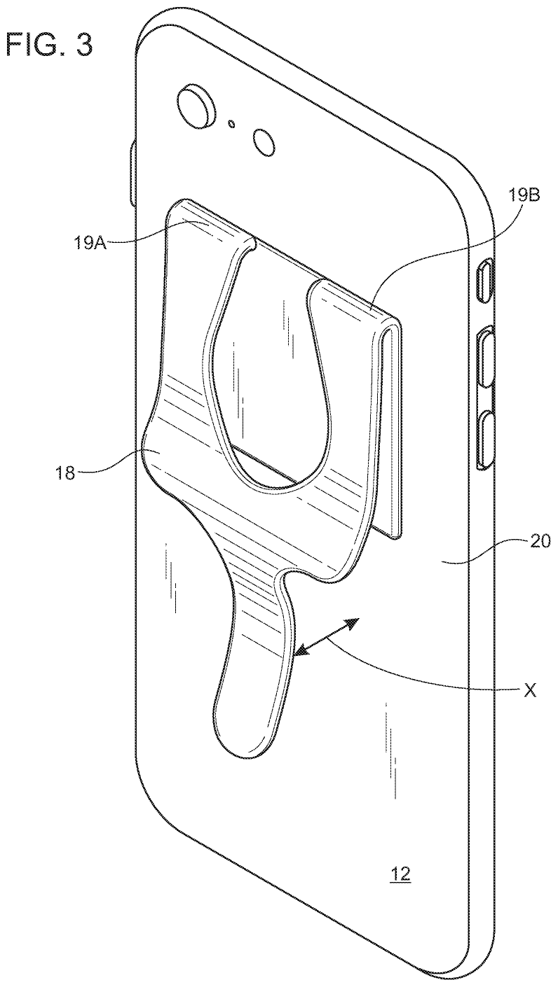

In the illustrated embodiment, the spring 19 is formed integral with the base 14 and spring bar 13 as a plastic spring comprising first and second spring portions 19A and 19B, respectively. In other embodiments the spring 19 can be formed using other hinge types including a hinge formed separately from the base 14 and spring bar 18 and attached therebetween. The spring 19 is configured to hold the spring bar 18 spaced apart from the rear side 12 of the mobile phone 20 in a normal position. FIG. 3 includes the spacing between the rear side 12 of the mobile phone 20 and the spring bar 18 shown as a distance “X” at one point along the spring bar.

As shown in FIG. 4, in the illustrated embodiment, the spring bar 18 defines a generally paddle shape having a center line Y-Y extending through a length thereof. The spring bar 18 includes a first portion 23 disposed adjacent to the spring 19 and being generally rectangular having a width approximately equal to a width W of the base 14. In one embodiment the width W of the first portion 23 of the spring bar 18 is about 1.5 inches to about 2 inches.

The first portion 23 of the spring bar 18 defines a central opening 26 through the thickness thereof. The central opening 26 allowing space for a portion of a user's fingers 24 to extend through the central opening or to provide a area to receive a finger of a user to grip the mobile phone 24. In the illustrated embodiment the central opening 26 is generally tear shaped, however in other embodiments, the first portion of the spring bar 18 can include a central opening of a different shape or the central opening may be omitted and the first portion solid throughout the width thereof. As shown in FIG. 7, the spring bar 18 shown in the Figures defines a. uniform thickness “t” throughout the length thereof.

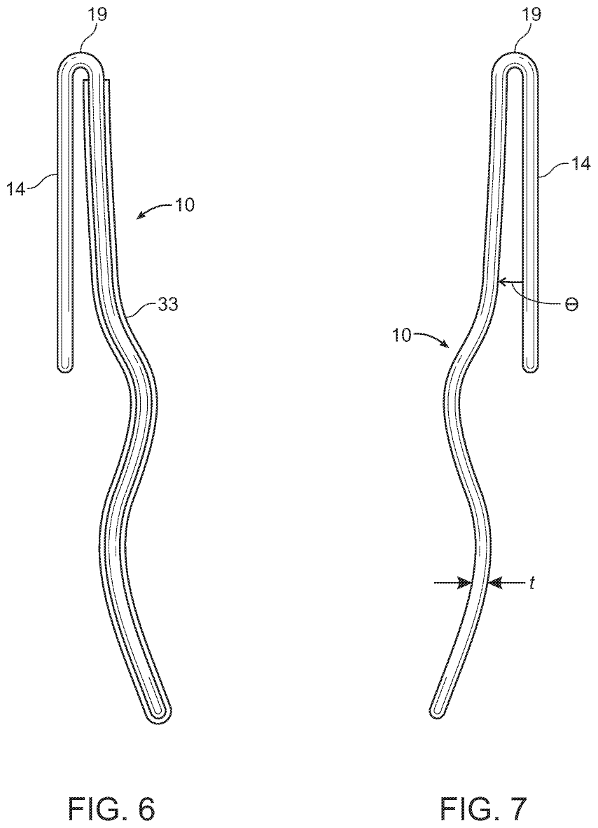

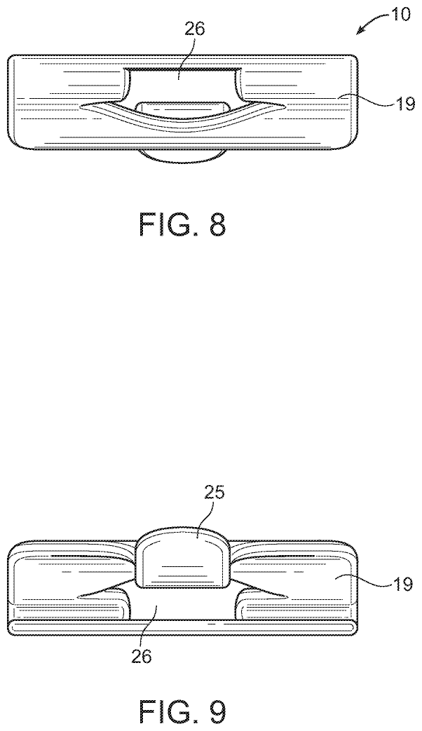

Referring to FIG. 4, the spring bar 18 further includes a second portion 25 being an elongated member extending outwardly from the first portion 23 from a side “A” of the first portion opposite the spring 19. The second portion 25 being centered lengthwise about the center line Y-Y of the spring bar 18. As shown in FIGS. 6 and 7, the second portion 25 defines a plurality bends 29, 31, 33 along the length thereof for varying the spacing X measured between the base 14 and the second portion 25 throughout a length of the second portion 25. As shown in FIGS. 6 and 7, the bends 29 and 33 have a radius of curvature in a first direction and the intermediate bend 31 has a radius of curvature in a direction opposite that of the bends 29 and 33. The bends 29, 31, 33 provide a variation in the spacing X so that users have comfortable spacing for their fingers 24 between the spring bar 18 and the read side 12 of the mobile phone or the base 14. The varied spacing X allows users having hands of different size, and either left or right handed users to comfortably position their fingers 24 between the spring bar 18 and the rear side 12 of the mobile phone or the base 14.

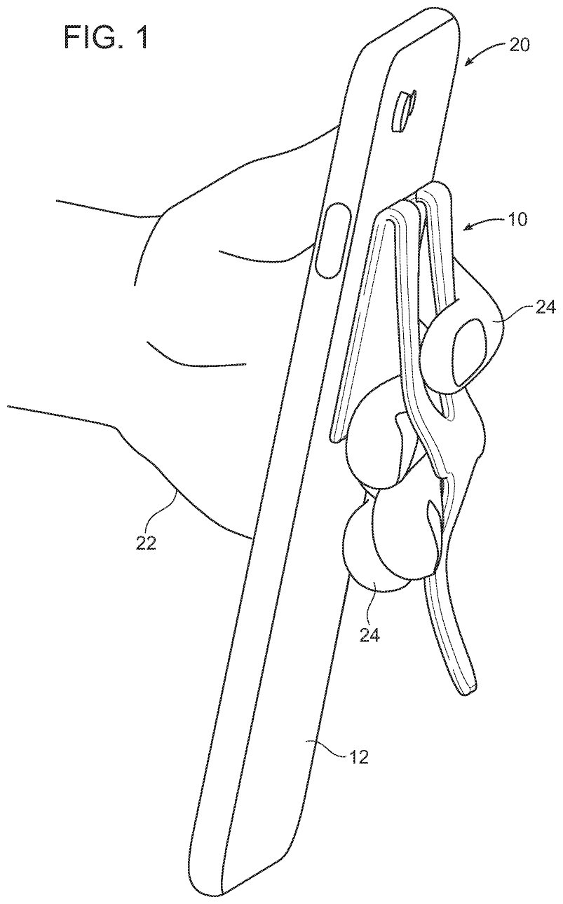

As shown in the FIG. 1 embodiment, the spacing “X” is designed so that a user's fingers 24 will not fit between the spring bar 18 and the rear side 12 of the mobile phone 20 throughout a length of the spring bar 18 without moving the spring bar 18 outwardly from the mobile phone 20. Thus, the spring bar is urged against a back side of the user's fingers 24 securing the fingers between the mobile phone 20 and the spring bar 18.

As shown in FIG. 6, a rubber sleeve 33 is disposed over the first and second portions 23, 25 of the spring bar 18 to increase a coefficient of friction between the user's fingers 24 and the spring bar. The sleeve 33 can be configured to cover the split first portion 23 and leave open the opening 26 defined by the first portion 23 of the spring bar.

In another embodiment, the spring bar 18 is formed from a soft plastic wherein the surfaces of the spring bar 18 facing the mobile telephone 12 provides a slip resistant surface so a user's fingers placed between the spring bar 18 and the mobile phone 12 are securely held therebetween due to the tension of the spring 19 which urges the spring bar 18 against the user's fingers. Accordingly, in some embodiments of the phone holder 10, the rubber sleeve 33 may not be included and would not be necessary.

In another embodiment, a surface of the first and second portions 23 and 25 of the spring bar 18 facing the mobile phone 12 include a rubber or rubber-like layer attached thereto for providing a slip resistant surface on at least one of the first and second portions 23 and 25 so that the user hand is secured to the mobile phone 20 via the spring bar 18.

The tension of the spring 19 is configured to secure the mobile phone 20 to the fingers 24 of the user even if the user is not grasping the mobile phone 20 or the hand of the user is pointed in a downward direction. Thus, the disclosed phone holder 10 provides a secure attachment between the users fingers 24 and the mobile phone 20.

Example embodiments and methods thus being described, it will be appreciated by one skilled in the art that example embodiments may be varied through routine experimentation and without further inventive activity. Variations are not to be regarded as departure from the spirit and scope of the exemplary embodiments, and all such modifications as would be obvious to one skilled in the art are intended to be included within the scope of the following claims.

What is claimed is:

1. A phone holder for use with a mobile telephone, the phone holder comprising:
a generally planar base attachable to a rear side of a mobile telephone;
a spring bar attached to the base, the spring bar being angularly disposed relative to the base in a normal position; and
a spring coupled between the base and the spring bar, the spring being configured to urge the spring bar towards the base when the spring bar is moved outwardly from the base beyond the normal position.

2. The phone holder of claim 1 wherein the spring is a plastic spring formed integrally with the base and the spring bar.

3. The phone holder of claim 1 wherein the spring is a mechanical spring coupled between the base and the spring bar.

4. The phone holder of claim 1 wherein the base further comprises an adhesive layer on a first side thereof for attaching the base to a mobile telephone.

5. The phone holder of claim 1 wherein the spring bar is paddle shaped including a first portion and a second portion, the first portion

6. The phone holder of claim 1 wherein the spring bar is formed of a soft plastic material.

7. The phone holder of claim 1 wherein the spring bar further comprises a rubber covering for increasing a coefficient of friction between the spring bar and a user's fingers.

8. The phone holder of claim 1 wherein a portion of the spring bar defines an opening for receiving a portion of a user's fingers therethrough.
